(19) United States
(12) Patent Application Publication
(10) Pub. No.: US 2002/0166447 A1
(43) Pub. Date: Nov. 14, 2002

(54) Hydraulic cylinder unit including pivot elements

(75) Inventors: Jurgen Thomas, Dusseldorf (DE); Andreas Rosele, Wanfried (DE)

Correspondence Address: George M. Thomas, Thomas, Kayden, Horstemeyer & Risley, LLP, Suite 1750, 100 Galleria Parkway, N.W, Atlanta, GA, 30339-5948, US

(73) Assignee: Hyco Pacoma GmbH

(21) Appl. No.: 10/135,659

(22) Filed: Apr. 30, 2002

(30) Foreign Application Priority Data
May 9, 2001 (DE) 10122512.1-14

(51) Int. Cl. F16J 15/18; F01B 11/02

(52) U.S. Cl. 92/169.1; 92/165 R

(57) ABSTRACT

A hydraulic cylinder unit includes a cylinder tube. A piston is movable in the interior of the cylinder tube in the direction of the cylinder axis. A piston rod has a first end and a second end, the first end being connected to the piston and the second end protruding outside the cylinder tube in the region of the second end of the cylinder tube. A bottom element is located in the region of the first end of the cylinder tube, and it is designed and arranged to seal the first end of the cylinder tube and the interior of the cylinder tube. An oil connection element is located in the region of the bottom element, and it is designed and arranged to allow for oil entering and exiting the interior of the cylinder tube through the oil connection element. A pivot unit includes a thread, and it is designed and arranged to be connected to the cylinder tube by the thread, the pivot unit including at least one pivot element being designed and arranged to support the hydraulic cylinder in a pivotable way. A ring includes a thread, and it is designed and arranged to be connected to the cylinder tube by the thread and to contact the pivot unit. The pivot unit and the ring are designed to be arranged on the cylinder tube in locking engagement in each desired turning position about the cylinder axis with respect to the bottom piece and to the oil connection element.

### CROSS REFERENCE TO RELATED APPLICATIONS

This application claims the benefit of co-pending German Patent Application No. 101 22 512.1-14 entitled “Hydraulikzylinder mit Schwenkzapfen”, filed on May 9, 2001.

### FIELD OF THE INVENTION

The present invention generally relates to a hydraulic cylinder unit. More particularly, the present invention relates to a hydraulic cylinder unit including a pivot unit and pivot elements.

The present invention also relates to a method of producing such a hydraulic cylinder unit.

### BACKGROUND OF THE INVENTION

Hydraulic cylinder units including a pivot unit, a pivot head or a so called trunnion are generally known in the art. Some known pivot units are designed as forge units including pivot elements to guide the piston rod and to seal an annular space of the hydraulic cylinder except for an oil connection element through which oil may flow. In this way, the number of elements of the hydraulic cylinder is comparatively low. Furthermore, such a forge element only requires a few mechanical process steps during which material is removed. In the known hydraulic cylinder units, the relative position of the pivot unit with respect to the cylinder tube is defined by mutual contact of the pivot unit and the cylinder tube in an axial direction, or in other words by a fixed stop. Consequently, the angle position of the pivot unit with respect to the cylinder tube varies due to unpreventable tolerances of the contacting materials. Such tolerances are not critical when the cylinder tube and the bottom piece have rotationally symmetrical designs. However, when the oil connection element protrudes from the bottom piece in a radial direction, the angle position of the oil connection element also varies with a variation due to tolerances which in many assembly positions of the known hydraulic cylinder cannot be accepted. Correspondingly, after having screwed the cylinder tube into the pivot unit, the bottom piece has to be connected to the cylinder tube by welding to attain the desired relative position of the oil connection element with respect to the pivot unit. After having realized this fixed connection, the angle position cannot be changed any more. To connect the pivot unit of the known hydraulic cylinder on the cylinder tube at a freely chosen angle position, it is known to use glue. However, to realize a lasting glue connection, the surfaces to be connected have to be free from oil, and the thread to be fixed by glue has to be clamped with outer units in a complicated way.

Another hydraulic cylinder is known from German Patent Application No. 193 216. The known hydraulic cylinder differs from the above described known cylinder only by the fact that the pivot unit is not connected to the cylinder tube by screwing it onto the cylinder tube, but into the cylinder tube. The relative position of the pivot unit with respect to the cylinder tube is defined by mutual stop contact. To realize a variable position of the pivot elements being located at the pivot unit, the known pivot unit may include a plurality of pieces or elements. In this way, the pivot elements may protrude from a ring in a radial direction, the ring being pushed on a cylinder jacket-like portion of the pivot unit to fit exactly. The cylinder jacket-like portion of the pivot unit surrounds the piston rod, and it is screwed into the cylinder tube. Furthermore, it includes another outer thread for a locknut to lock the ring with the pivot axes at a chosen rotational position of the ring with respect to the remainder of the hydraulic cylinder. In the known hydraulic cylinder, it is especially disadvantageous that the pivot unit has a design to include a plurality of pieces. This design makes it especially difficult to locate oil connection elements to allow for connection to the annular space of the hydraulic cylinder at the pivot unit.

Another hydraulic cylinder unit including a cylinder tube is known from International Application PCT/DE97/00039 published as WO 97/29287 which corresponds to U.S. Pat. No. 6,196,112. In the known hydraulic cylinder, a bottom piece is screwed onto one end of the cylinder tube, and a guiding piece for the piston rod is screwed onto the other end of the cylinder tube. The bottom piece is designed to lock, close and seal the end of the cylinder tube except for an oil connection element allowing for communication. In this way, the known cylinder tube is sealed with respect to the bottom piece and with respect to the guiding piece by corresponding elastic sealing surfaces. The known hydraulic cylinder is supported by its bottom piece to be pivotable. In this way, realizing a certain rotational position of the guiding piece about the cylinder axis is not of great importance to the known hydraulic cylinder.

### SUMMARY OF THE INVENTION

The present invention relates to a hydraulic cylinder unit including a cylinder tube having an interior, a first end and a second end and defining a cylinder axis. A piston is designed and arranged to be movable in the interior of the cylinder tube in the direction of the cylinder axis. A piston rod has a first end and a second end, the first end being connected to the piston and the second end being designed and arranged to protrude outside the cylinder tube in the region of the second end of the cylinder tube. A bottom element is located in the region of the first end of the cylinder tube, and it is designed and arranged to seal the first end of the cylinder tube and the interior of the cylinder tube. An oil connection element is located in the region of the bottom element, and it is designed and arranged to allow for oil entering and exiting the interior of the cylinder tube through the oil connection element. A pivot unit includes a thread, and it is designed and arranged to be connected to the cylinder tube by the thread, the pivot unit including at least one pivot element being designed and arranged to support the hydraulic cylinder in a pivotable way. A ring includes a thread, and it is designed and arranged to be connected to the cylinder tube by the thread and to contact the pivot unit. The pivot unit and the ring are designed to be arranged on the cylinder tube in locking engagement in each desired turning position about the cylinder axis with respect to the bottom piece and to the oil connection element.

In the novel hydraulic cylinder unit, the pivot unit may be located at each desired rotational position about the cylinder axis since it may be secured thereon by fixing it with the ring or locking ring at each desired angle position. In this way, it is possible to realize a desired rotational position of the bottom piece and of the oil connection element, respectively, with respect to the pivot elements being located at the pivot unit. Locking the pivot unit on the cylinder tube does not require thorough cleaning of the respective contact surfaces, and it does not require outer units to clamp the threads. The locking contact between the ring and the so called trunnion may be easily undone to realize a different rotational position of these two elements. At the same time, there is no danger of unintentionally changing the adjusted rotational position. With the novel hydraulic cylinder unit, it is possible to reach the desired rotational position of the pivot unit about the cylinder axis with respect to the bottom piece in a simple way despite any occurring tolerances.

In the novel hydraulic cylinder unit, the bottom piece element may be connected in a simple way to the cylinder tube by welding, or it may be screwed into the cylinder tube to contact a stop to realize sealing engagement with respect to the cylinder tube without having to take into account the relative position about the cylinder axis even when the oil connection element or oil supply conduit of the bottom piece extends in a radial direction away from the cylinder axis. Occurring tolerances in the resulting rotational position of the bottom element with respect to the cylinder tube are compensated when determining the position of the pivot unit by the locking ring.

Preferably, the pivot unit forms a guiding element to guide the piston rod during its reciprocating movement to reduce the number of individual components in the novel hydraulic cylinder unit. When the hydraulic cylinder unit is designed to be double-acting, the pivot unit may also be designed and arranged to seal an annular space of the hydraulic cylinder except for an oil connection element through which oil may pass at certain times.

In an especially preferred exemplary embodiment of the novel hydraulic cylinder unit, the pivot unit including the pivot elements is designed as a one-piece forge element, and the ring is designed as a forge element being made of the same material as the pivot unit. Optimizing the materials for the pivot unit, on the one hand, and for the ring, on the other hand, separately may lead to choosing different materials. However, the pivot unit and the ring of the novel hydraulic cylinder unit preferably are designed as two sections of one single forge form element.

It is to be understood that the ring may be designed to include appropriate engagement surfaces for cooperation with a known rotational tool—and not just as a simple ring—to be capable of applying greater locking forces or counter forces by the engagement surfaces.

The present invention also relates to a novel method of producing the novel hydraulic cylinder unit. The method includes the steps of inserting the piston into the cylinder tube, screwing the ring onto the cylinder tube, screwing the pivot unit onto the cylinder tube, attaching the piston to the piston rod, and attaching the bottom piece to the cylinder tube.

Preferably, the bottom piece is connected to the cylinder tube by welding. The piston rod preferably is connected to the piston by a thread.

An especially preferred way of conducting the novel method includes the additional steps of producing a forge form element, producing an inner thread at the forge form element, and separating the forge form element to form the pivot unit including pivot elements and the ring. In this way, one may produce the novel hydraulic cylinder in its especially preferred exemplary embodiment in which the pivot unit or trunnion and the locking ring are designed as forge elements being made of the same material.

Another preferred detail of the above described novel method includes the use of the following steps: producing a continuous inner channel in the forge form element by cutting into a continuous inner surface of the forge form element before the step of producing the inner thread at the inner surface of the forge form element, and cutting off the ring along the continuous inner channel after the step of producing the inner thread to separate the forge form element to form the pivot unit and the ring.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a longitudinal sectional view of the novel hydraulic cylinder unit.

FIG. 2 is a view of a detail of the novel hydraulic cylinder unit of FIG. 1.

FIG. 3 is a top view of the novel hydraulic cylinder unit of FIG. 1 as seen from the free end of the piston rod.

FIG. 4 is a longitudinal sectional view of a novel forge form element being designed to form the pivot unit and the ring of the novel hydraulic cylinder unit of FIGS. 1-3.

### DETAILED DESCRIPTION

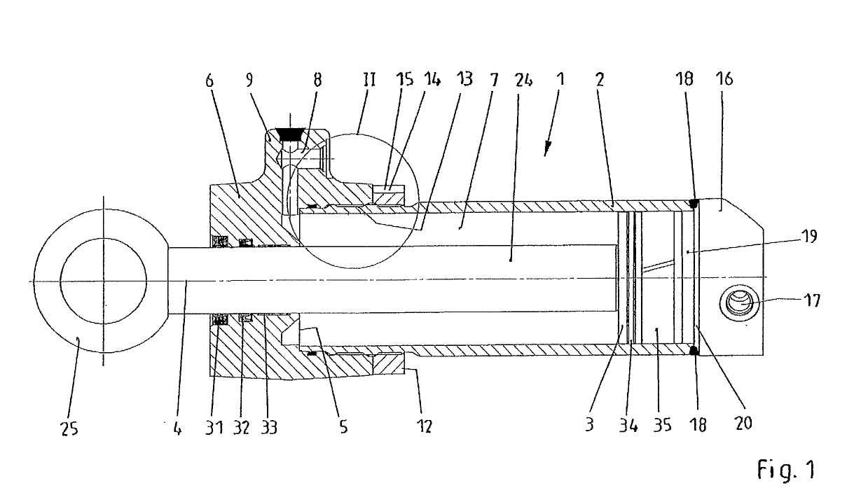

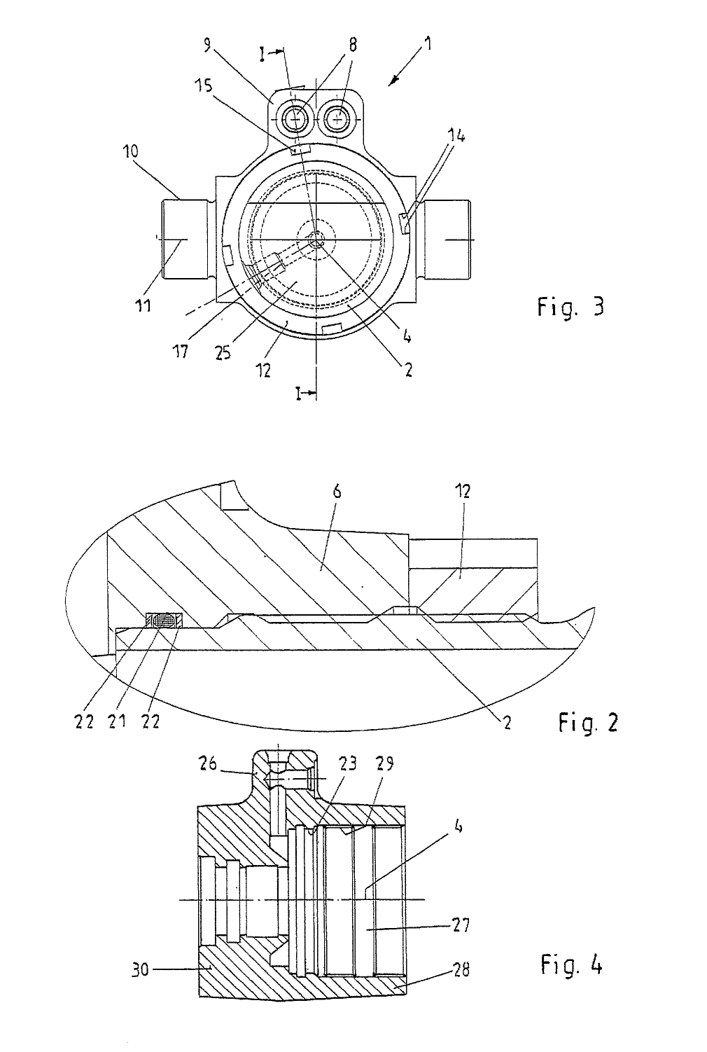

Referring now in greater detail to the drawings, FIGS. 1-3 illustrate a hydraulic cylinder 1 including a cylinder tube 2 in which a piston 3 is arranged to be movable back and forth in the direction of a cylinder axis 4. A piston rod 24 is fixedly connected to the piston 3. The piston rod 24 exits at one end 5 of the cylinder tube 2, and it is supported by a pivot unit 6. The pivot unit 6 may also be called a pivot head or a trunnion. The pivot unit 6 is screwed onto the cylinder tube 2 by a thread, and at the end 5 it seals an annular space 7 of the hydraulic cylinder 1 except for oil connections 8 which still allow oil to communicated during certain conditions. The oil connections 8 extend through a piece 9 in a radial direction towards the outside. The pivot unit 6 is called like this since it includes at least one pivot element 10 or pivot tappet (FIG. 3).

In the illustrated exemplary embodiment of the novel hydraulic cylinder 1, the pivot unit 6 includes two pivot elements 10 being located in an opposing position with respect to the cylinder axis 4 (FIG. 3). The pivot elements 10 serve to support the hydraulic cylinder 1. The hydraulic cylinder 1 is designed and arranged to be pivotable about a pivot axis 11, meaning the common center axis of the pivot elements 10. In this way, the hydraulic cylinder unit 1 is pivoted about the pivot axis 11 during its function. The pivot position or turning position of the pivot unit 6 and of the pivot elements 10 with respect to the cylinder tube 2 may be chosen, and it is determined by a ring element 12 being screwed onto the cylinder tube 2 by the same outer thread 13. The locking ring 12 includes channels 15 and surfaces 14 being designed and arranged to apply a suitable force by a respective tool (not illustrated).

Usually, the possibility of adjusting and determining a certain rotational position of the pivot unit 6 and of the pivot elements 10, respectively, with respect to the cylinder tube 2 is of no great interest, since the cylinder tube 2 is designed to be rotationally symmetrical with respect to the cylinder axis 4. A lug 25 or an eye may be arranged at the free end of the piston rod 24 to be freely rotatable. Something else applies to a bottom piece 16 of the hydraulic cylinder 1. An oil connection element 17 extends from the bottom piece 16 in a radial direction, for example in a direction approximately perpendicular to the plane of illustration of FIG. 1. Due to the possibility of adjusting the rotational position of the pivot unit 6, the position of the oil connection element 17 with respect to the pivot elements 10 may be exactly determined, and it may be coordinated with a certain assembly position of the hydraulic cylinder 1, respectively. The bottom piece element 16 is fixedly connected to the cylinder tube 2 by a welding joint 18. The welding joint 18 also realizes the sealing effect of the piston space 19 at the end 20 of the cylinder tube 2 opposing the end 5. An outer thread (not illustrated) is arranged at a protrusion of the piston rod 24 to connect the piston rod 24 to the piston 3. After having inserted the piston rod 24 through the pivot unit 6 into the cylinder tube 2, the connection is realized by either screwing the piston 3 directly onto the outer thread of the piston rod 2, or by screwing a nut (not illustrated) being supported at the piston 3 onto the outer thread. A piston seal 34 and a guiding band 35 are designed and arranged to slide along the inner wall of the cylinder tube 2. The cylinder tube 2 is sealed with respect to the pivot unit 6 by an O-ring seal being located between two supporting rings 22. A wiper element 31, a rod seal element 32 and a guiding band element 33 are located at the pivot unit 6 to cooperate with the piston rod 24.

Especially when one produces the novel hydraulic cylinder 1 in series, many elements of the hydraulic cylinder 1, especially the piston 3, the pivot unit 6 including the ring 12 and the bottom piece 16 may be designed as forge elements without losses due to removing material by chipping in the stage of the final processing steps. Preferably, the pivot unit 6 and the ring 12 are designed to initially be one single forge element, as this is illustrated in FIG. 3. An annular inner channel 27 is cut in an inner surface 23 of the forge form element 26. The inner surface 23 is designed and arranged to be rotationally symmetrical with respect to the cylinder axis 4. The inner channel 27 separates the region 30 from the region 28 of the forge form element 26. The region 30 corresponds to the later pivot unit 6, and the region 28 corresponds to the later ring 12. Then, an inner thread 29 is produced at the inner surface 23. Typically, the inner thread 29 is cut into the surface 23 beyond the inner channel 27 to cover both at least parts of the regions 30 and 28. In the following, the region 28 separated from the region 30 by cutting into the inner channel 27 from the inside or from the outside. In this way, the pivot unit 6 and the ring 12 are produced from the forge form element 26. Cutting into the inner channel 27 after having produced the inner thread 29 or even not using an inner channel 27 at all may cause damage of the inner thread 29 when separating the counter ring 12. Furthermore, it is preferred to produce the channels 15 with the counter surfaces 14 at the counter ring 12 which has already been separated by cutting. In the following, the ring 12 is screwed onto the outer thread 13 of the cylinder tube 2, and after that the pivot unit 6 is screwed onto the other thread 13 at the cylinder tube 2. Since the pivot unit 6 and the ring 12 have been produced based on one forge form element 26, they are made of the same material.

Many variations and modifications may be made to the preferred embodiments of the invention without departing substantially from the spirit and principles of the invention. All such modifications and variations are intended to be included herein within the scope of the present invention, as defined by the following claims.

We claim:

1. A hydraulic cylinder unit, comprising:
a cylinder tube having an interior, a first end and a second end and defining a cylinder axis;
a piston being designed and arranged to be movable in the interior of said cylinder tube in the direction of the cylinder axis;
a piston rod having a first end and a second end, said first end being connected to said piston and said second end being designed and arranged to protrude outside said cylinder tube in the region of said second end of said cylinder tube;
a bottom element being located in the region of said first end of said cylinder tube and being designed and arranged to seal said first end of said cylinder tube and the interior of said cylinder tube;
an oil connection element being located in the region of said bottom element and designed and arranged to allow for oil entering and exiting said interior of said cylinder tube through said oil connection element;
a pivot unit including a thread and being designed and arranged to be connected to said cylinder tube by said thread, said pivot unit including at least one pivot element being designed and arranged to support said hydraulic cylinder in a pivotable way; and
a ring including a thread and being designed and arranged to be connected to said cylinder tube by said thread and to contact said pivot unit,
said pivot unit and said ring being designed to be arranged on said cylinder tube in locking engagement in each desired turning position about the cylinder axis with respect to said bottom piece and to said oil connection element.

2. The hydraulic cylinder unit of claim 1, wherein said oil connection element is designed and arranged to extend in a radial direction with respect to the cylinder axis.

3. The hydraulic cylinder unit of claim 1, wherein said pivot unit is designed and arranged to support said piston rod.

4. The hydraulic cylinder unit of claim 2, wherein said pivot unit is designed and arranged to support said piston rod.

5. The hydraulic cylinder unit of claim 3, further comprising a second oil connection element being located in the region of said second end of said cylinder tube and being designed and arranged to allow for oil entering and exiting said interior of said cylinder tube through said second oil connection element, an annular space being located between said cylinder tube and said pivot rod and said pivot unit being designed and arranged to seal said annular space in a way that oil in the region of said second end of said cylinder tube can only enter and exit said interior of said cylinder tube through said second oil connection element.

6. The hydraulic cylinder unit of claim 4, further comprising a second oil connection element being located in the region of said second end of said cylinder tube and being designed and arranged to allow for oil entering and exiting said interior of said cylinder tube through said second oil connection element, an annular space being located between said cylinder tube and said pivot rod and said pivot unit being designed and arranged to seal said annular space in a way that oil in the region of said second end of said cylinder tube can only enter and exit said interior of said cylinder tube through said second oil connection element.

7. The hydraulic cylinder unit of claim 1, wherein said pivot unit includes a plurality of pivot elements, said pivot unit and said pivot elements being designed as a one-piece forge unit, and said ring being designed as a forge element made of the same material as said pivot unit.

8. The hydraulic cylinder unit of claim 1, wherein said ring includes engagement surfaces being designed and arranged to cooperate with a tool for rotational movement of said ring with respect to said cylinder tube.

9. The hydraulic cylinder unit of claim 1, wherein said pivot unit and said ring are located in the region of said second end of said cylinder tube in a way to first screw said ring onto said cylinder tube and to then screw said pivot unit onto said cylinder tube such that said ring is located between said pivot unit and said bottom element.

10. The hydraulic cylinder unit of claim 1, wherein said piston rod includes a lug being located at its second end being designed and arranged to protrude outside said cylinder tube in the region of said second end of said cylinder tube.

11. A hydraulic cylinder, comprising:
a cylinder tube having a first end;
an oil connection element;
a bottom piece being designed and arranged to close said first end of said cylinder tube except for said oil connection element;
a piston being designed and arranged to be guided in said cylinder tube in the direction of a cylinder axis;
a piston rod having a first end and a second end, said piston rod with its first end being connected to said piston and with its second end being designed and arranged to protrude outside of said cylinder tube;
a pivot unit being designed and arranged to form at least one pivot element to support said hydraulic cylinder in a way to be pivotable, said pivot unit including a thread and being designed and arranged to be connected to said cylinder tube by said thread;
a ring including a thread and being designed and arranged to be connected to said cylinder tube by said thread in a way to be screwed onto said cylinder tube before said pivot unit,
said pivot unit and said counter ring being designed and arranged to be commonly fixed on said cylinder tube in each desired turning position about the cylinder axis with respect to said bottom piece and to said oil connection element.

12. The hydraulic cylinder of claim 11, wherein said oil connection element is designed and arranged to extend in a radial direction with respect to the cylinder axis.

13. The hydraulic cylinder of claim 11, wherein said pivot unit is designed and arranged to support said piston rod.

14. The hydraulic cylinder of claim 12, wherein said pivot unit is designed and arranged to support said piston rod.

15. The hydraulic cylinder of claim 13, further comprising a second oil connection element being located in the region of said second end of said cylinder tube and being designed and arranged to allow for oil entering and exiting said interior of said cylinder tube through said second oil connection element, an annular space being located between said cylinder tube and said pivot rod and said pivot unit being designed and arranged to seal said annular space in a way that oil in the region of said second end of said cylinder tube can only enter and exit said interior of said cylinder tube through said second oil connection element.

16. The hydraulic cylinder of claim 14, further comprising a second oil connection element being located in the region of said second end of said cylinder tube and being designed and arranged to allow for oil entering and exiting said interior of said cylinder tube through said second oil connection element, an annular space being located between said cylinder tube and said pivot rod and said pivot unit being designed and arranged to seal said annular space in a way that oil in the region of said second end of said cylinder tube can only enter and exit said interior of said cylinder tube through said second oil connection element.

17. The hydraulic cylinder of claim 11, wherein said pivot unit includes a plurality of pivot elements, said pivot unit and said pivot elements being designed as a one-piece forge unit, and said ring being designed as a forge element made of the same material as said pivot unit.

18. The hydraulic cylinder of claim 11, wherein said ring includes engagement surfaces being designed and arranged to cooperate with a tool for rotational movement of said ring with respect to said cylinder tube.

19. The hydraulic cylinder of claim 11, wherein said pivot unit and said ring are located in the region of said second end of said cylinder tube in a way to first screw said ring onto said cylinder tube and to then screw said pivot unit onto said cylinder tube such that said ring is located between said pivot unit and said bottom element.

20. The hydraulic cylinder of claim 11, wherein said piston rod includes a lug being located at its second end being designed and arranged to protrude outside said cylinder tube in the region of said second end of said cylinder tube.

21. A method of producing a hydraulic cylinder unit a cylinder tube having an interior, a first end and a second end and defining a cylinder axis, a piston being designed and arranged to be movable in the interior of the cylinder tube in the direction of the cylinder axis, a piston rod having a first end and a second end, the first end being connected to the piston and the second end being designed and arranged to protrude outside the cylinder tube in the region of the second end of the cylinder tube, a bottom element being located in the region of the first end of the cylinder tube and being designed and arranged to seal the first end of the cylinder tube and the interior of the cylinder tube, an oil connection element being located in the region of the bottom element and designed and arranged to allow for oil entering and exiting the interior of the cylinder tube through the oil connection element; a pivot unit including a thread and being designed and arranged to be connected to the cylinder tube by the thread, the pivot unit including at least one pivot element being designed and arranged to support the hydraulic cylinder in a pivotable way, and a ring including a thread and being designed and arranged to be connected to the cylinder tube by the thread and to contact the pivot unit, the pivot unit and the ring being designed to be arranged on the cylinder tube in locking engagement in each desired turning position about the cylinder axis with respect to the bottom piece and to the oil connection element, said method comprising the steps of:
inserting the piston into the cylinder tube;
screwing the ring onto the cylinder tube;
screwing the pivot unit onto the cylinder tube;
attaching the piston to the piston rod; and
attaching the bottom piece to the cylinder tube.

22. The method of claim 21, wherein in the step of attaching the bottom piece to the cylinder tube the bottom piece is connected to the cylinder tube by welding.

23. The method of claim 21, further comprising the steps of:
producing a forge form element;
producing an inner thread at the forge form element; and
separating the forge form element to attain the pivot unit including the pivot elements and the ring.

24. The method of claim 22, further comprising the steps of:
producing a forge form element;
producing an inner thread at the forge form element; and
separating the forge form element to attain the pivot unit including the pivot elements and the ring.

25. The method of claim 24, further comprising the steps of:
producing a continuous inner channel in the forge form element by cutting into a continuous inner surface of the forge form element before the step of producing the inner thread at the inner surface of the forge form element; and
cutting off the ring along the continuous inner channel after the step of producing the inner thread to separate the forge form element to form the pivot unit and the ring.
